(19) United States
(12) Patent Application Publication
(10) Pub. No.: US 2004/0086708 A1
(43) Pub. Date: May 6, 2004

(54) High permeability soft magnetic composites

(75) Inventors: Amitabh Verma, Bangalore (IN); Luana Emiliana Iorio, Clifton Park, NY (US); K. Anand, Bangalore (IN); Srinidhi Sampath, Bangalore (IN); Robert John Zabala, Schenectady, NY (US); Kanchan Kumari, Bangalore (IN); Geetha Karavoor, Kerala (IN)

Correspondence Address: General Electric Company, CRD Patent Docket Rm 4A59, Bldg. K-1, P.O. Box 8, Schenectady, NY, 12301, US

(73) Assignee: General Electric Company

(21) Appl. No.: 10/287,036

(22) Filed: Nov. 4, 2002

(51) Int. Cl. B32B 5/16

(52) U.S. Cl. 428/329; 428/323; 428/492

(57) ABSTRACT

Soft magnetic composites having a high compressibility and a high permeability are described. These two characteristics are obtained by combining high compressibility iron powder to high permeability powders. The iron powder is of a high compressibility and in a size range and proportion that results in a powder mass amenable to compaction by industrially viable and cost-effective compaction process such as uniaxial cold compaction. The high compressibility iron powder helps achieve high relative density and also allows easy path for the passage of magnetic flux.

### BACKGROUND OF THE INVENTION

This invention generally relates to chemical compounds. More particularly, this invention related to soft magnetic composite compounds. Even more particularly, this invention related to magnetic composite compounds that have both a high magnetic permeability as well as a high compressibility.

Soft magnetic composites (SMC) are being developed to provide materials with competitive magnetic properties (good relative permeability and magnetic saturation) as well as high electrical resistivity. The high resistivity makes these materials attractive in low loss applications, particularly at high frequencies. Unlike conventional laminated materials, the magnetic permeability is isotropic and the isotropy of properties removes the constraints on design imposed on conventional electrical machines by lamination. SMCs contain a ferromagnetic particle coated with an insulating material which produces the high bulk electrical resistivity. As well, the SMC precursor powder is carefully formulated to produce a high density product when cold or warm compacted, which is essential to the viability of SMC in practical applications.

One such application of SMCs is to replace laminates in many end uses. By replacing the laminates, the SMCs also reduce the cost and enhance productivity by decreasing the scrap generation problems accompanying laminates. A key to achieving this goal, however, is the availability of a SMC with a magnetic permeability of greater than about 1000 at 1 T.

There are several approaches for obtaining this high permeability characteristic in SMC. Use of high permeability ferromagnetic powders in the SMCs is one approach. However, most high permeability ferromagnetic powders suffer from the disadvantage of poor compressibility resulting from the higher hardness. This approach therefore requires expensive and low throughput compaction techniques such as warm compaction, dynamic compaction or cold/hot isostatic pressing. Without these techniques, SMCs of low relative density and high porosity are obtained, characteristics that are detrimental to the magnetic permeability of the SMC.

These problems raised in this approach of obtaining high permeability SMCs are presently addressed by two methods. The first method is using compaction processes such as warm compaction, dynamic compaction, explosive compaction or cold/hot isostatic pressing. These processes are, however, beset with the disadvantage of high capital investment, high process cost and low throughput. The second method is adding high percentages of polymer to the SMC to facilitate densification. However, polymers are non-ferromagnetic in nature and reduce the total volume percentage of the magnetic material in the SMC, which adversely affects the magnetic permeability.

### BRIEF SUMMARY OF THE INVENTION

The invention provides soft magnetic composites having a high compressibility and a high permeability. These two characteristics are obtained by combining high compressibility iron powder to high permeability powders. The iron powder is of a high compressibility and in a size range and proportion that results in a powder mass amenable to compaction by industrially viable and cost-effective compaction process such as uniaxial cold compaction. The high compressibility iron powder helps achieve high relative density and also allows easy path for the passage of magnetic flux.

The invention includes a method for making a magnetic composite material by providing a high compressibility powder with a first average particle size, providing a high permeability powder with a second average particle size, mixing the two powders, coating the high compressibility powder, the high permeability powder, both the high compressibility powder and the high permeability powder, or the powder mixture with an agent, and compacting the powder mixture. The invention further includes a method for making a magnetic composite material by providing a high compressibility powder with a first average particle size, providing a high permeability powder with a second average particle size, mixing the two powders, coating the high compressibility powder, the high permeability powder, both the high compressibility powder and the high permeability powder, or the powder mixture with an agent, compacting the powder mixture, and annealing the compacted powder mixture. The invention also includes a method for making a magnetic composite material by providing iron powder with a first average particle size, providing a high permeability powder with a second average particle size, mixing the two powders, coating the high compressibility powder, the high permeability powder, both the high compressibility powder and the high permeability powder, or the powder mixture with an agent comprising silicone, compacting the powder mixture, and annealing the compacted powder mixture. The invention still further includes magnetic composite materials made by such methods.

The invention also includes a magnetic composite material comprising a high compressibility powder having a first average particle size and a high permeability powder having a second average particle size, wherein the high compressibility powder, the high permeability powder, or both are coated with an agent comprising silicone. The invention further includes a magnetic composite material comprising a high compressibility powder having a first average particle size and a high permeability powder having a second average particle size, wherein the material has a relative density of least about 80% and wherein the high compressibility powder, the high permeability powder, or both are coated with an agent. The invention also includes a magnetic composite material, comprising a high compressibility powder having a first average particle size and a high permeability powder having a second average particle size, wherein the material has a relative density of about 95 to about 97% and wherein the high compressibility powder, the high permeability powder, or both are coated with an agent. The invention still further includes a magnetic composite material, comprising a high compressibility powder comprising iron having a first average particle size and a high permeability powder having a second average particle size, wherein the material has a relative density of about 95 to about 97% and wherein the high compressibility powder, the high permeability powder, or both are coated with an agent comprising silicone. The invention yet further includes devices containing such materials.

### DETAILED DESCRIPTION OF THE INVENTION

The following description provides specific details in order to provide a thorough understanding of the invention. The skilled artisan, however, would understand that the invention can be practiced without employing these specific details. Indeed, the present invention can be practiced by modifying the illustrated system and method and can be used in conjunction with apparatus and techniques conventionally used in the industry.

As noted above, the invention generally comprises mixing high compressibility powders (HCPs) and high magnetic permeability powders (HPPs) or high magnetization saturation powders with differential size ranges to obtain SMCs with a high relative density. In one aspect of the invention, the HPPs powders can be any of those known in the art that provide the SMC with a permeability higher than that of pure iron (Fe). Examples of HPPs include alloys containing iron, nickel, cobalt, silicon, aluminum, or boron, or combinations thereof. In one aspect of the invention, Fe—Ni alloys are used as the HPP. The form of the powder can be any particulate shape, such as spherical powders, fibers, and flakes. The HPP materials may be crystalline or amorphous in structure.

As noted above, the size of the HPP is selected with respect to the size of the HCP. In one embodiment, the sizes of the HCP and the HPP can be substantially the same (equal) to obtain the high density of the SMC. In another embodiment, the HCP can have a first particle size and the HPP can have a second particle size wherein the first particle size can be equal to, greater than or less than the second particle size. As well, the size of the HPP depends on the desired magnetic properties of the SMC and can therefore be tailored to obtain such properties. In another aspect of the invention, the HPP average particle size can range from about 1 to about 500 micrometers. In another aspect of the invention, the HPP average particle size can range from about 5 to about 300 micrometers. As an example, an average particle size of about 200 to about 300 micrometers are employed when the HCP average particle size ranges from about 10 to about 40 micrometers.

In one aspect of the invention, the HCPs can be any of those known in the art that provide the SMC with a high compressibility. Examples of HCPs include ferromagnetic particles with low yield strengths, such as high purity iron. In one aspect of the invention, pure iron is used as the HCP. The form of the HCP can be any particulate shape, such as spherical powders, fibers, and flakes.

As noted above, the size of the HCP is selected with respect to the size of the HPP. In one aspect of the invention, the HCP average particle size can range from about 1 to about 500 micrometers. In another aspect of the invention, the HCP average particle size can range from about 200 to about 400 micrometers. In another aspect of the invention, the HCP average particulate size can be at least about 10 times smaller than the HPP. As an example, an average particle size of about 10 to about 40 micrometers are employed when the HCP average particle size ranges from about 200 to about 300 micrometers.

The respective amounts of the HCP and the HPP powders in the SMC depends on the desired magnetic permeability and/or magnetic saturation. In one aspect of the invention, the amount of HCP can range from about 10 to about 99 wt %. In another aspect of the invention, the amount of HCP can range from about 10 to about 50 wt %. In one aspect of the invention, the amount of HPP can range from about 90 to about 99 wt %. In another aspect of the invention, the amount of HCP can range from about 90 to about 50 wt %.

The HCP and HPP are then mixed in any conventional manner that provides a substantially homogenous mixture. During the mixing process, mixing additives can optionally be used to enhance the mixing of the two powders. The mixture of the two powders (the powder mixture) is then coated with a thin layer of an agent. The agent aids in the compaction process, aids in electrically insulating the individual power particles, and reduces the friction between the powders as described in more detail below. Any agent aiding in these functions can be used in the invention. Examples of such agents include binders, polymers, lubricants like zinc stearate, silicone, or a combination thereof. In one aspect of the invention, the agent is silicone.

The agent can be coated on the powder mixture using any coating process, such as spraying, vapor deposition, dipping, or a combination thereof. In one aspect of the invention, the silicone (or other agent) can be dissolved in xylene solvent to make a silicone solution and then the powder mixture in dipped in the solution. The solvent is evaporated off by application of vacuum and/or heat, leaving a silicone coating on the mixed powder. Typically, the silicone (or agent) coating has a thickness ranging from about 0.01 to about 2 micrometers.

In another aspect of the invention, the agent can be coated on the HCP, the HPP, or both prior to mixing. In this aspect of the invention, the agent can be selectively placed on only one powder as desired. As well, placing the agent on both powders prior to mixing can provide a better coating in certain aspects of the invention.

The thin layer of the agent can aid in the compaction of the powders. In one aspect of the invention, during the annealing process described below the silicone layer is converted to electrically insulating layer of silica. In another aspect of the invention, the agent (unlike silicone) is selected so that it remains unaltered-but still electrically insulating-during the annealing process. Thus, each particle is surrounded by an electrically insulating layer, which helps in reducing the eddy current loss.

After being coated, the powders are then compacted using any known compaction process. In one aspect of the invention, the powders are compacted using a uniaxial cold compaction process. This compaction process is usually carried out at room temperature and at a pressure ranging from about 60 to about 200 ksi. The powders can be compacted into any desired shape and size.

If desired, the compacted powders can then be annealed. The compacted shapes are annealed to remove the stresses introduced during compaction, achieving a higher permeability and a lower hysteresis loss. In the process of annealing the silicone (and any other appropriate agent) should not lose its electric insulating because it provides an electrically insulating layer between the ferromagnetic particles. The annealing process can be carried out under any conditions that will remove the stress from compaction. In one aspect of the invention, the compacted shapes are annealed at about 300 to about 800 degrees Celsius for about 10 to about 120 minutes. In the aspect of the invention where the HPP is in the form of flakes, the temperature can range from about 400 to about 500 degrees Celsius.

By judicious mixing of the HCPs and HPPS of differential size ranges, SMCs of high relative density (i.e., lower porosity) can be obtained. These high densities are obtained without the need of employing capital intensive and low throughput powder compaction techniques, such as warm compaction, dynamic compaction, hot/cold isostatic pressing, etc. Mixing these powders at lower compaction pressures reduces the wear on the die used in the compaction process that can be caused at higher pressures.

As well, by blending the HCP and the HPP and described above, the magnetization saturation (MS) of the SMC can be increased. For example, if the HCP is iron and the HPP is amorphous iron, the HCP will increase the MS of the SMC. As another example, if the HCP is iron and the HPP is a Fe—Co alloy, then the HPP will increase the MS.

Using the invention provides SMCs with a relative density of at least 80%. In one aspect of the invention, the SMCs have a relative density of about 95-97%. Such high SMC densities facilitate the achievement of high permeability. Through the invention, by adding high compressibility powder to hard powder improves the adhesion and helps to interlock the powders, achieving a mechanical strength better than possible by compacting brittle powders alone.

The invention also provides a cost savings over conventional materials. The compressible iron powders (and in some instances, the other HCPs) are relatively less expensive compared to high permeability powders containing nickel, cobalt, or amorphous materials. By mixing these lower cost powders with the more expensive powders provides opportunities for overall material cost reduction without sacrificing the desirable characteristics of the SMC.

The SMCs of the invention can also contain other components as known in the art. For example, the SMCs can contain various kinds of fillers such as fibrous fillers, plate-like fillers, and spherical fillers to improve the mechanical properties, heat resistance, and the like. As well, the SMC can contain various kinds of additives such as flame-retardants, antioxidants, and colorants.

The SMCs of the invention can be used in the manufacture of numerous devices as known in the art. See, for example, U.S. Pat. Nos. 4,601,765, 5,352,522, 5,595,609, and 5,754,936, as well as U.S. Patent Publication No. US20020023693 A1.

The following non-limiting examples illustrate the invention.

### EXAMPLE 1

Pure iron powder without any coating was mixed in various proportions with Fe—Ni powder without any coating. The pure iron powder was a water-atomized irregular shaped powder with high compressibility. The Fe—Ni powder was a gas atomized spherical powder with a lower compressibility relative to the iron powder.

The powder size for both powders was between 90-125 microns, obtained by sieving the starting powder. The two powders were mixed separately in varying proportions, from 0% Fe to 100% Fe. 16 mm diameters pellets were then compacted at 140 ksi. The theoretical densities along with the calculated porosities are presented in Table 1.

The corresponding values of the densities obtained is also presented in Table 1. Table 1 demonstrates that pure Fe—Ni cannot sustain the compaction pressure, and the sample broke. With 10% iron powder added, the resulting porosity is 10%, which reduced to about 3% porosity with about 80% iron powder.

TABLE 1

| Wt % | | | Theoretical | |
|---|---|---|---|---|
| Fe—Ni | Wt % Fe | Density (g/cc) | Density (g/cc) | % Porosity |
| 100 | 0 | sample broke | 8.20 | N.A. |
| 90 | 10 | 7.34 | 8.16 | 9.9 |
| 80 | 20 | 7.47 | 8.12 | 8.0 |
| 70 | 30 | 7.44 | 8.08 | 7.9 |
| 60 | 40 | 7.52 | 8.04 | 6.5 |
| 50 | 50 | 7.52 | 8.00 | 6.0 |
| 40 | 60 | 7.51 | 7.95 | 5.5 |
| 30 | 70 | 7.57 | 7.92 | 4.3 |
| 20 | 80 | 7.60 | 7.88 | 3.5 |
| 10 | 90 | 7.57 | 7.84 | 3.4 |
| 0 | 100 | 7.56 | 7.80 | 3.1 |

No magnetic property measurements were measured. However, toroidal ring samples were made by mixing 35 wt % pure iron powder with 65 wt % Fe—Ni powder (theorectical density of about 7.8 g/cc). The powders were mixed thoroughly by putting them in a plastic bottle and running it in a rack mill for about 20 minutes. The mixed powder was then compacted into a ring at 110 ksi with a density of 7.25 g/cc and a porosity of 8.6% based on the theoretical density of the mixture of 7.94 g/cc. The magnetic property of the blended Fe/Fe—Ni powders (with no coating) is presented in Table 2, along with the processing details.

TABLE 2

| | | | | | Core loss | Hysteresis | Eddy current |
|---|---|---|---|---|---|---|---|
| Compaction | Annealing | | | Peak | at 1T, | loss at | loss at 1T, |
| pressure | Temperature | Density | % | permeability | 60 Hz | 1T, 60 Hz | 60 Hz |
| (ksi) | (° C.) | (g/cc) | Porosity | at 60 Hz | (W/lb) | (W/lb) | (W/lb) |
| 110 | 800 (for 0.5 | 7.25 | 8.6 | 284 | 7.8 | 3.5 | 4.3 |
| | hr) | | | | | | |

### EXAMPLE 2

In this example, the powders were coated with silicone. Both pure iron and Fe—Ni (50 wt % Ni) in a size range of 125-180 mincrons were coated separately with 0.125 wt % silicone coating in a Rotovac process. 35 wt % of the coated iron powder was mixed with 65 wt % of the coated Fe—Ni powder in a rack mill similar to Example 1. Using the blended coated powders, several ring samples were compacted at 154 ksi and annealed for 30 minutes at 700, 800, and 1100 degrees Celsius. The results of the magnetic property along with the processing conditions are listed in Table 3.

TABLE 3

| Compaction | Annealing | | | Peak | Core loss | Hysteresis | Eddy current |
|---|---|---|---|---|---|---|---|
| pressure | Temperature | Density | % | permeability | at 1T, 60 | loss at 1T, | loss at 1T, |
| (ksi) | (° C.) | (g/cc) | Porosity | at 60 Hz | Hz (W/lb) | 60 Hz (W/lb) | 60 Hz (W/lb) |
| 154 | 800, 0.5 hr | 7.61 | 3.8 | 311 | 5 | 2.6 | 2.4 |
| 154 | 700, 0.5 hr | 7.54 | 4.7 | 270 | 2.7 | 2.1 | 0.5 |
| 154 | 1100, 0.5 hr | 7.61 | 3.8 | 390 | 19 | 5.5 | 13.5 |

Having described these aspects of the invention, it is understood that the invention defined by the appended claims is not to be limited by particular details set forth in the above description, as many apparent variations thereof are possible without departing from the spirit or scope thereof.

What is claimed is:

1. A method for making a magnetic composite material, comprising:
providing a high compressibility powder with a first average particle size;
providing a high permeability powder with a second average particle size;
mixing the two powders;
coating the high compressibility powder, the high permeability powder, both the high compressibility powder and the high permeability powder, or the powder mixture with an agent; and
compacting the powder mixture.

2. The method of claim 1, further including annealing the compacted mixture.

3. The method of claim 1, wherein the first and second average particle sizes are different.

4. The method of claim 1 wherein the first and second average particle sizes are about equal.

5. The method of claim 1 wherein the first average particle size greater than the second average particle size.

6. The method of claim 1 wherein the first average particle size less than the second average particle size.

7. The method of claim 1, wherein the high permeability powder comprises an alloy.

8. The method of claim 7, wherein the alloy comprises iron, nickel, cobalt, silicon, aluminum, boron or combinations thereof.

9. The method of claim 1, wherein the high compressibility powder comprises iron.

10. The method of claim 1, wherein the agent comprises silicone.

11. The method of claim 10, further comprising coating the silicone on the powder mixture.

12. The method of claim 1, further comprising compacting the powder mixture using a uniaxial cold compaction process.

13. A method for making a magnetic composite material, comprising:
providing a high compressibility powder with a first average particle size;
providing a high permeability powder with a second average particle size;
mixing the two powders;
coating the high compressibility powder, the high permeability powder, both the high compressibility powder and the high permeability powder, or the powder mixture with an agent;
compacting the powder mixture; and
annealing the compacted powder mixture.

14. The method of claim 13, wherein the high compressibility powder comprises iron.

15. The method of claim 13, wherein the agent comprises silicone.

16. The method of claim 15, further comprising coating the silicone on the powder mixture.

17. The method of claim 13, further comprising compacting the powder mixture using an uniaxial cold compaction process.

18. The method of claim 13 wherein the first and second average particle sizes are about equal.

19. The method of claim 13 wherein the first average particle size greater than the second average particle size.

20. The method of claim 13 wherein the first average particle size less than the second average particle size.

21. The method of claim 13, wherein the high permeability powder comprises an alloy.

22. The method of claim 21, wherein the alloy comprises iron, nickel, cobalt, silicon, aluminum, boron or combinations thereof.

23. A method for making a magnetic composite material, comprising:
providing iron powder with a first average particle size;
providing a high permeability powder with a second average particle size;
mixing the two powders;
coating the high compressibility powder, the high permeability powder, both the high compressibility powder and the high permeability powder, or the powder mixture with an agent comprising silicone;
compacting the powder mixture; and
annealing the compacted powder mixture.

24. The method of claim 23, further comprising compacting the powder mixture using an uniaxial cold compaction process.

25. A magnetic composite material made by the method comprising:
providing a high compressibility powder with a first average particle size;
providing a high permeability powder with a second average particle size;
mixing the two powders;
coating the high compressibility powder, the high permeability powder, both the high compressibility powder and the high permeability powder, or the powder mixture with an agent; and
compacting the powder mixture.

26. A magnetic composite material made by the method comprising:
providing a high compressibility powder with a first average particle size;
providing a high permeability powder with a second average particle size;
mixing the two powders;
coating the high compressibility powder, the high permeability powder, both the high compressibility powder and the high permeability powder, or the powder mixture with an agent;
compacting the powder mixture; and
annealing the compacted powder mixture.

27. A magnetic composite material made by the method comprising:
providing iron powder with a first average particle size;
providing a high permeability powder with a second average particle size;
mixing the two powders;
coating the high compressibility powder, the high permeability powder, both the high compressibility powder and the high permeability powder, or the powder mixture with an agent comprising silicone;
compacting the powder mixture; and
annealing the compacted powder mixture.

28. An un-compacted magnetic composite material, comprising:
a high compressibility powder having a first average particle size; and
a high permeability powder having a second average particle size;
wherein the high compressibility powder, the high permeability powder, or both are coated with an agent comprising silicone.

29. The un-compacted magnetic composite material of claim 28 wherein the first and second average particle sizes are about equal.

30. The un-compacted magnetic composite material of claim 28 wherein the first average particle size greater than the second average particle size.

31. The un-compacted magnetic composite material of claim 28 wherein the first average particle size less than the second average particle size.

32. The un-compacted magnetic composite material of claim 28, wherein the high permeability powder comprises an alloy.

33. The un-compacted magnetic composite material of claim 32, wherein the alloy comprises iron, nickel, cobalt, silicon, aluminum, boron or combinations thereof.

34. A magnetic composite material, comprising:
a high compressibility powder having a first average particle size; and
a high permeability powder having a second average particle size;
wherein the material has a relative density of least about 80% and wherein the high compressibility powder, the high permeability powder, or both are coated with an agent.

35. The material of claim 34, wherein the relative density ranges from about 95% to about 97%.

36. The material of claim 34, wherein the agent comprises silica.

37. The material of claim 34, wherein the high compressibility powder comprises iron.

38. The material of claim 34 wherein the first and second average particle sizes are about equal.

39. The material of claim 34 wherein the first average particle size greater than the second average particle size.

40. The material of claim 34 wherein the first average particle size less than the second average particle size.

41. The material of claim 34, wherein the high permeability powder comprises an alloy.

42. The material of claim 41, wherein the alloy comprises iron, nickel, cobalt, silicon, aluminum, boron or combinations thereof.

43. A magnetic composite material, comprising:
a high compressibility powder having a first average particle size; and
a high permeability powder having a second average particle size;
wherein the material has a relative density of about 95 to about 97% and wherein the high compressibility powder, the high permeability powder, or both are coated with an agent.

44. The material of claim 43, wherein the agent comprises silica.

45. The material of claim 43, wherein the high compressibility powder comprises iron.

46. The material of claim 43 wherein the first and second average particle sizes are about equal.

47. The material of claim 43 wherein the first average particle size greater than the second average particle size.

48. The material of claim 43 wherein the first average particle size less than the second average particle size.

49. The material of claim 43, wherein the high permeability powder comprises an alloy.

50. The material of claim 49, wherein the alloy comprises iron, nickel, cobalt, silicon, aluminum, boron or combinations thereof.

51. A magnetic composite material, comprising:
a high compressibility powder comprising iron having a first average particle size; and
a high permeability powder having a second average particle size;
wherein the material has a relative density of about 95 to about 97% and wherein the high compressibility powder, the high permeability powder, or both are coated with an agent comprising silica.

52. The material of claim 51 wherein the first and second average particle sizes are about equal.

53. The material of claim 51 wherein the first average particle size greater than the second average particle size.

54. The material of claim 51 wherein the first average particle size less than the second average particle size.

55. The material of claim 51, wherein the high permeability powder comprises an alloy.

56. The material of claim 55, wherein the alloy comprises iron, nickel, cobalt, silicon, aluminum, boron or combinations thereof.

57. A device containing a magnetic composite material comprising:
a high compressibility powder having a first average particle size; and
a high permeability powder having a second average particle size;
wherein the material has a relative density of least about 80% and wherein the high compressibility powder, the high permeability powder, or both are coated with an agent.

58. A device containing a magnetic composite material comprising:
a high compressibility powder having a first average particle size; and
a high permeability powder having a second average particle size;
wherein the material has a relative density of about 95 to about 97% and wherein the high compressibility powder, the high permeability powder, or both are coated with an agent.

59. A device containing a magnetic composite material comprising:
a high compressibility powder comprising iron having a first average particle size; and
a high permeability powder having a second average particle size;
wherein the material has a relative density of about 95 to about 97% and wherein the high compressibility powder, the high permeability powder, or both are coated with an agent comprising silica.
